(19) United States
(12) Patent Application Publication
(10) Pub. No.: US 2012/0110913 A1
(43) Pub. Date: May 10, 2012

(54) Aluminum Door Keyed Removable Mullion

(76) Inventor: Timothy Greenfield, Dubuque, IA (US)

(21) Appl. No.: 12/943,528

(22) Filed: Nov. 10, 2010

(51) Int. Cl. E06B 1/52

(52) U.S. Cl. 49/365

(57) ABSTRACT

An aluminum door removable mullion positioned between a door frame and a base plate. The mullion is secured between a top mount latch plate and the mullion tube encases the base plate. The mullion being comprised of a double fin door tube serves as an obstruction against the outdoor elements by providing a barrier all around the door. The mullion further contains a locking mechanism housed within its cavity to allow authorized removal of the mullion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING

Not Applicable

### BACKGROUND OF THE INVENTION

This invention relates to a keyed removable mullion for aluminum doors that fits securely between two single openings which can easily be removed by a turning a key for the space of a double. There is currently no commercial keyed removable mullion on the market like this invention.

A mullion is generally defined as a vertical bar or pier that forms a division between two single doors. Single doors generally require the space needed of doubles to move things in and out, such as equipment. Traditional removable mullions must be unscrewed or unbolted from the top and/or bottom to create an unobstructed space. This can require a lot of time and is a general hindrance. Repeated removal of this type of mullion can loosen the fittings and damage screws, creating a need for frequent replacement of hardware. All previous removable mullions are fitted inside of the door(s) creating the need for weather stripping to shield from the elements.

The early mullions pivoted to allow the pier to swing out of the door while remaining in the frame. U.S. Pat. No. 2,275,730 shows a mullion which swings forward on a bracket and is held by a retracting chain, permitting the mullion to be removed. This is an example of the release system not being protected from the outdoor elements and unauthorized tampering.

Previous removable mullions easily damage from the repeated removal of the hardware, exposure to the elements, or unauthorized tampering, making them a disadvantage. This created the need for a locking mechanism. U.S. Pat. Nos. 5,435,102 and 5,450,697 provide the locking mechanism needed to be tamper resistant while offering the removable mullion qualities. These mullions that contain the locking mechanism do not sit flush with the frame. These sit on the inside of the doors leaving space between the doors for elements like air and water to come through, whereas this invention is a division between the two single doors. These mullions are copious and visually unappealing.

There is a need for a mullion which sits flush with the doors for visual appeal while shielding from outdoor elements. This invention simulates the frame and sits between the doors, it appears as one piece. This mullion is a barrier from the elements, not just a detractor.

### SUMMARY OF THE INVENTION

This invention alleviates the predicaments described above, while bringing further enhancements to the traditional removable mullion. The present invention provides energy efficiency by having the double fin door tube positioned between the single doors; therefore no gaps exist. Protection from the elements is provided around the perimeter of the door, on the inside and out.

This present invention sits between two single doors and is flush with the frame giving the option to create the space occasionally needed of two doubles. It is the most visually appealing mullion option.

Whereas previous removable mullions used screws and/or bolts for removal, all that is needed for removal of this mullion is the key. The mullion can easily be removed by one person in a matter of seconds. The latch plate is connected to the frame to encase the top of the mullion; the bottom of the mullion tube embodies the base plate. The only object that has to be removed for double door space is the middle pier itself, everything else stays in place.

Enhancements and advantages of the present invention are shown through the accompanying drawings and their descriptions.

### BRIEF DESCRIPTION OF THE SEVERAL VIEWS OF THE DRAWING

FIG. 1 breaks down the invention to its simplest form. It shows the latch plate connecting to the frame at the top. The base plate connects with the threshold at the bottom. With the mullion tubing and the locking mechanism being held within these two objects as a removable piece.

FIG. 2 shows how the mullion stands as one adjoining unit in its locked position. The door fins are solid black to demonstrate where the doors butt up for element containment.

FIG. 3 illustrates the mullion pier disconnecting from the latch plate and the base. This would be its unlocked position.

FIG. 4 discloses the internal components of the locking mechanism that attaches into the double fin door tube at top.

### DETAILED DESCRIPTION OF THE INVENTION

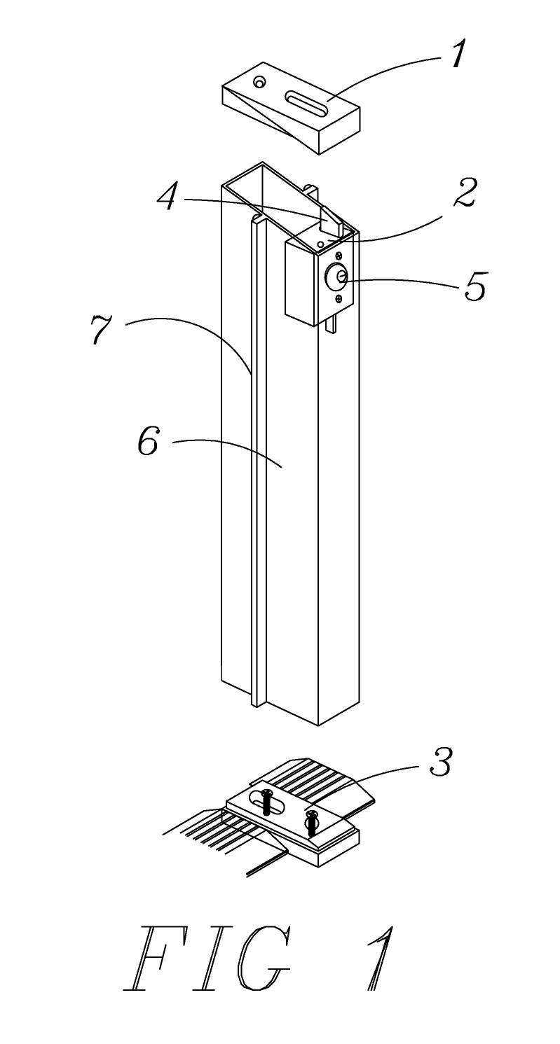

As shown in FIG. 1, the double fin door tube mullion unit 6 is shown in basic form, sitting between the latch plate 1 and the base plate 3 in a standard double door frame. Whereas prior mullion inventions would sit on the inside of the door, this invention is positioned between the two singles to create a permanent barrier from the elements. This mullion 6 is constructed from extruded aluminum with its cavity sized to hold the locking mechanism 2 retaining the top end and accommodating the base plate 3 at bottom. Previous mullion inventions have many separate components to retain the mullion structure, whereas this mullion is securely held by these two elements in a locked position.

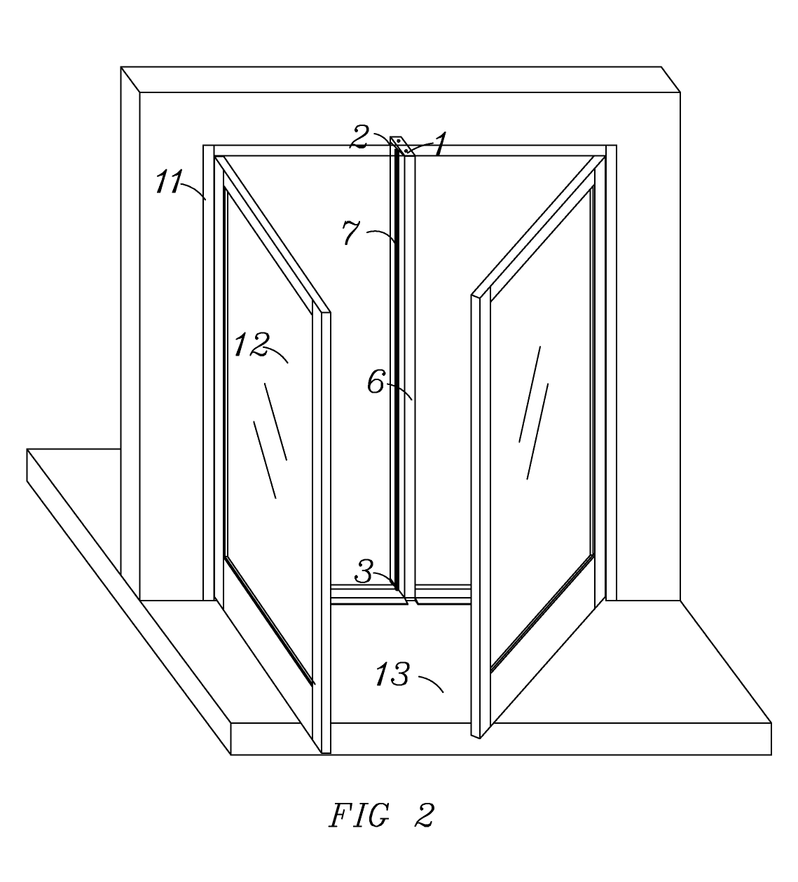

FIG. 2 is showing the mullion 6 in the vertical locked position with the surrounding retaining components. This figure best shows the forging of the mullion 6 with the weather stripping 7 in the center of the mullion tube to alleviate the previous inventions exposure to outside elements. The double fin door tube 6 allows airflow only when the door is employable. The latch plate 1 is affixed to the door frame 11 at top and the base plate 3 is secured between the thresholds on the floor 13.

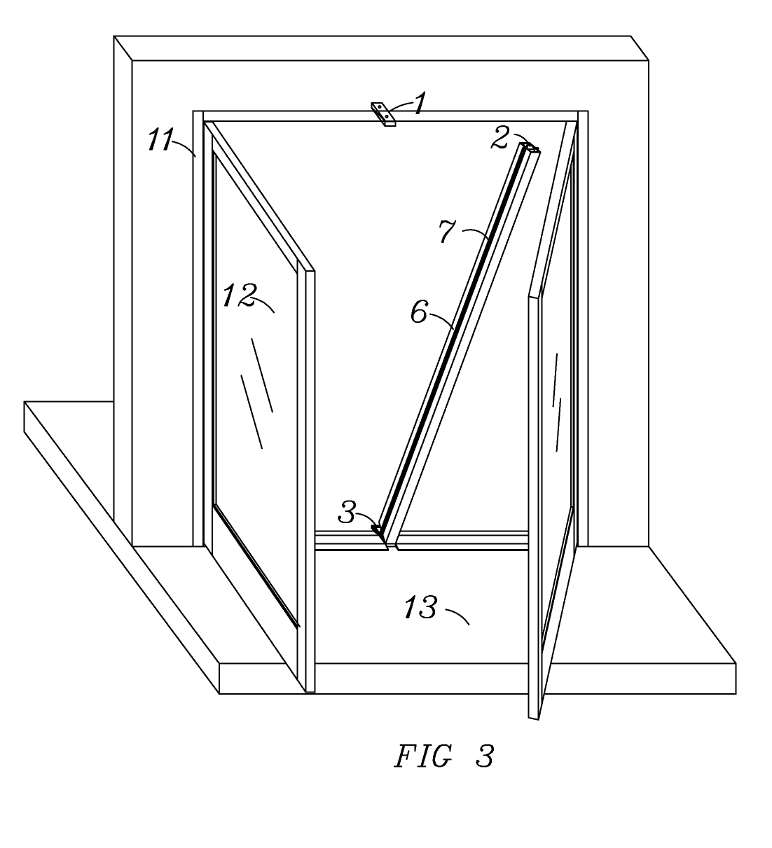

FIG. 3 illustrates the actual view of how the mullion unit 6 disconnects from the latch plate 1 secured by the frame 11 and the base plate 3 with the doors 12 ajar. The locking mechanism 2 is housed at the top of this unlocked mullion unit 6 inside the mullion cavity for access only from within the dwelling. It is apparent in this view how the double fin door tube 6 fitting entrenches the base plate 3 to alleviate the unwanted air flow and maintenance issues from previous inventions.

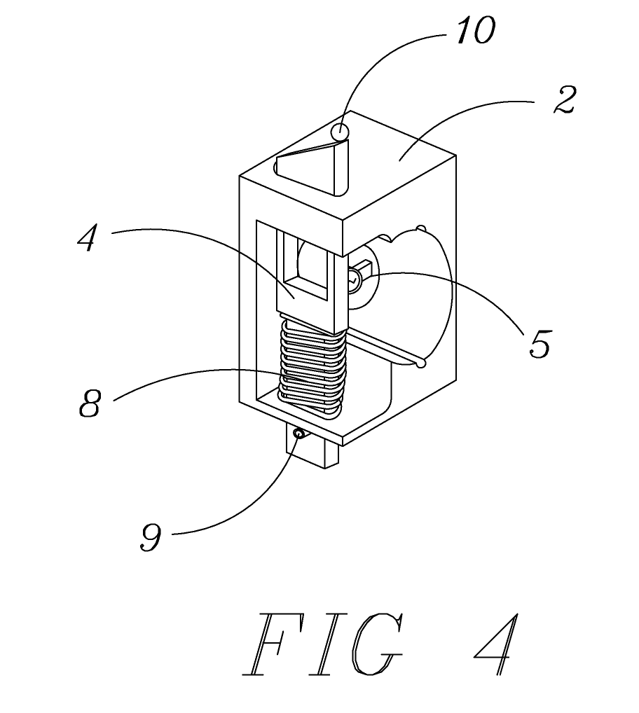

FIG. 4 incorporates the locking mechanism 2 held within its mounting block 2 attached to the mullion 6 cavity by a retaining screw 10. Having the locking mechanism housed within the door tube at top eliminates debris that was a predicament in previous inventions and eliminates tampering as it can only be reached from inside the structure. The standard mortise cylinder 5 is where the key enters to unlock the strike 4 for removal of the mullion 6. The turn of the key contracts the spring 8 and initiates the C-4 tang 5 to release the strike 4 from within the latch plate 1. The roll pin 9 secures the strike in place. Once this is done, simply dislodge the mullion at top and pop bottom from base.

Those with knowledge or skill in this area will appreciate the simplicity of this invention. It is easy to install, easy to use, and easy to maintain. There are minimal components necessary to achieve the overall goal of what a mullion is intended.

I claim:

1. A removable mullion specified for an aluminum door entranceway to adapt a single door opening twofold, comprised of:
a mullion formed by a double fin door tube;
a latch plate to retain the mullion to the frame;
a base plate attached to the floor between thresholds to receive the mullion footing;
a double fin door tube cavity positioned between the latch plate and base plate;
a locking mechanism housed within the mullion cavity containing a key lock cylinder which upon engagement permits the mullion to be removed from the doorway

2. The mullion comprised of claim 1, in which the locking mechanism is comprised of:
a mounting block with a retaining screw hole to anchor the locking mechanism within the mullion cavity
a strike to retain the mullion in its latch plate while in locked position
a tang to activate the strike when removal is initiated
a spring to allow the strike to glide up and down
a roll pin to restrain the strike within the mounting block
